(19) United States
(12) Patent Application Publication
(10) Pub. No.: US 2011/0084502 A1
(43) Pub. Date: Apr. 14, 2011

(54) Linear Rotary Generator

(76) Inventors: Faramarz Frank Ghassemi, Calabasas, CA (US); Michael Alexander Ryssemus, Boulder Creek, CA (US); Karl Albert Ryssemus, Cupertino, CA (US)

(21) Appl. No.: 12/898,262

(22) Filed: Oct. 5, 2010

Related U.S. Application Data
(60) Provisional application No. 61/251,716, filed on Oct. 14, 2009.

(51) Int. Cl. F03G 7/08

(52) U.S. Cl. 290/1 R

(57) ABSTRACT

A linear rotary generator includes a magnet, a housing defining a cavity receiving the magnet, and a solenoid around the cavity. The magnet has a magnetic axis that rotates about a rotational axis as the magnet rolls along a direction perpendicular to the rotational axis. As the magnet passes through the solenoid, it induces an alternating current in the solenoid. The rotary power generator may be fixed to an object experiencing motion, which causes the magnet to roll in the housing and generate electricity for the object.

### CROSS REFERENCE TO RELATED APPLICATIONS

This application claims the benefit of U.S. Provisional Application No. 61/251,716, filed Oct. 14, 2009, which is incorporated herein by reference.

### FIELD OF INVENTION

This invention relates to generation of power using gravity and inertia.

### DESCRIPTION OF RELATED ART

The global technological challenges for the next two decades of the 21st century include extensive and rapid consumption of energy and need for production of such energy. For example, gasoline consumption by automobiles in the United States is equivalent to several trillion kilowatt-hours (KWH) of electricity. Even if just 20% of the automobiles is converted to electric cars, then the electrical grid of the United States has to come up with nearly a trillion KWH of extra power to charge these electric cars. Additional demands for electrical power come from the increasing number of households with multiple computers, televisions, and telecommunication devices, and large server farms from corporations such as Google, Yahoo, and Microsoft, which may each have the demand for electricity on the scale of an entire city.

Therefore, the creation of clean electric energy, especially renewable kind like wind, geothermal, solar, and others is essential.

### SUMMARY

In one or more embodiments of the present disclosure, a linear rotary generator includes a magnet, a housing defining a cavity receiving the magnet, and a solenoid around the cavity. The magnet has a magnetic axis that rotates about a rotational axis as the magnet rolls along a direction perpendicular to the rotational axis. As the magnet passes through the solenoid, its magnetic field lines cut through wire loops of the solenoid and induce an alternating current in the solenoid in accordance with physical laws of electromagnetic induction. In one or more embodiments of the present disclosure, the linear rotary generator may be fixed to an object experiencing motion, which causes the magnet to roll in the housing and generate electricity for the object.

### BRIEF DESCRIPTION OF THE DRAWINGS

In the drawings:

FIG. 1 is a side view of a linear rotary generator with a rolling permanent magnet in one or more embodiments of the present disclosure;

FIG. 2 is a side view of the permanent magnet of FIG. 1 in a circular jacket in one or more embodiments of the present disclosure;

FIG. 3 is a side view of the linear rotary generator of FIG. 1 in an inclined orientation in one or more embodiment of the present disclosure;

FIG. 4 is a side view of a trace of a south pole of a permanent magnet in the inclined linear rotary generator of FIG. 3 in one or more embodiments of the present disclosure;

FIGS. 5 and 6 are side views showing the rotation of the magnetic field lines of the permanent magnet in the linear rotary generator of FIG. 1 in one or more embodiments of the present disclosure;

FIG. 7 is a side view of a linear rotary generator with increased rotations per linear distance traveled in one or more embodiments of the present disclosure;

FIGS. 8 and 9 are side views of an automobile with a linear rotary generator along the length of the automobile in one or more embodiments of the present disclosure;

FIG. 10 is a back view of the automobile of FIGS. 8 and 9 with another linear rotary generator along the width of the automobile in one or more embodiments of the present disclosure;

FIG. 11 is a side view of a watercraft with a linear rotary generator along the length of the watercraft in one or more embodiment of the present disclosure;

FIG. 12 is a top view of a watch with a linear rotary generator in one or more embodiments of the present disclosure;

FIG. 13 is a side view of a linear suspended magnet generator with a permanent magnet suspended in a solenoid in one or more embodiments of the present disclosure;

FIG. 14 is a perspective view of a trailer with the linear suspended magnet generator of FIG. 13 in one or more embodiments of the present disclosure;

FIG. 15 is a perspective view of a toy ball with the linear suspended magnet generator of FIG. 13 in one or more embodiments of the present disclosure; and

FIG. 16 is a side view of a linear rotary generator utilizing an alternator in one or more embodiments of the present disclosure.

Use of the same reference numbers in different figures indicates similar or identical elements.

### DETAILED DESCRIPTION

This disclosure is drawn, inter alia, to methods, apparatus, and systems related to a linear rotary generator. The linear rotary generator takes advantage of inertia and gravity stored and present in subject applications, such as land vehicles, watches, waves, and wind, to generate electricity. The linear rotary generator uses the force of gravity and inertia as sources of energy.

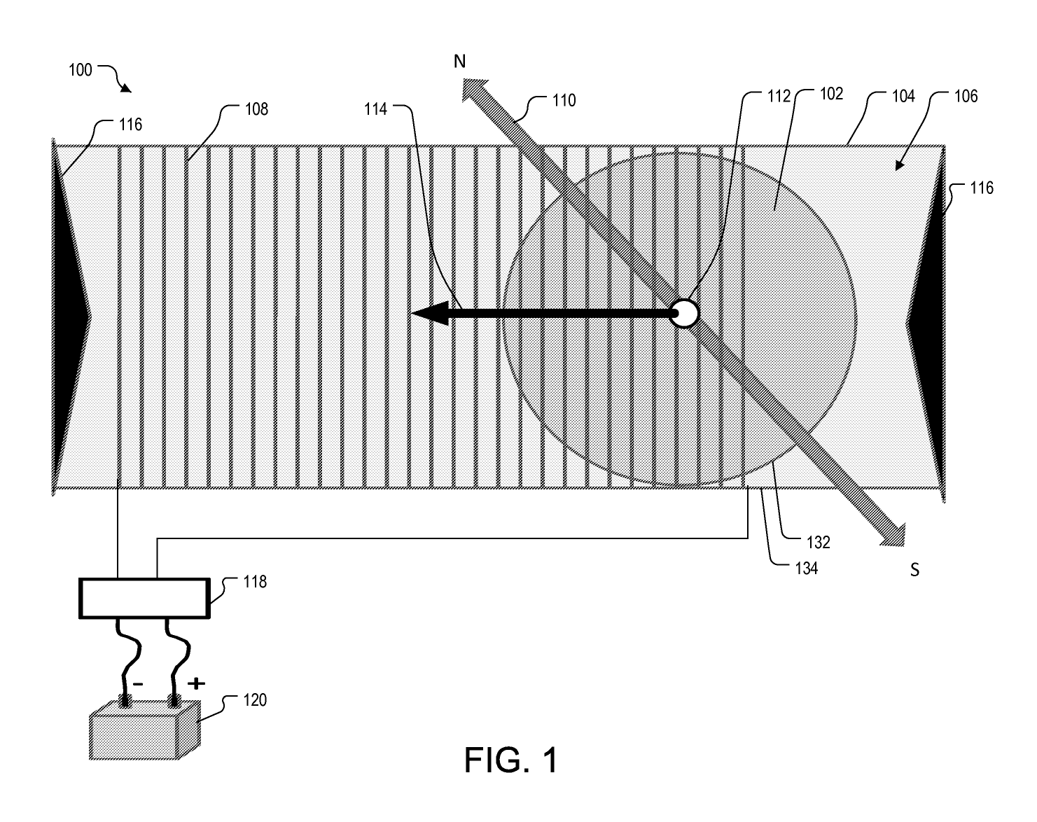

FIG. 1 is a side cross-sectional view of a linear rotary generator 100 in one or more embodiments of the present disclosure. Linear rotary generator 100 includes a permanent magnet 102, a housing 104 defining a cavity 106 receiving the permanent magnet, and a solenoid 108 around the cavity. Permanent magnet 102 has a magnetic axis 110 that rotates about a rotational axis 112 as the permanent magnet rolls along a direction 114 of motion perpendicular to the rotational axis. Linear rotary generator 100 operates most efficient when magnetic axis 110 is perpendicular to rotational axis 112 but their angle may vary depending on application. Housing 104 is made from a magnetically inert, optionally electrically insulating material such as plastic.

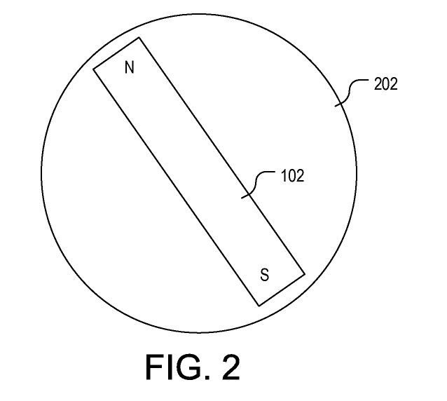

In one or more embodiments, permanent magnet 102 has a cylindrical shape so the axis of the cylindrical permanent magnet is rotational axis 112. In one or more other embodiments as shown in FIG. 2, a cylindrical jacket 202 encases permanent magnet 102 so the axis of the cylindrical jacket is rotational axis 112. Permanent magnet 102 may then have a non-cylindrical shape. Cylindrical jacket 202 is made from a magnetically inert, optionally electrically insulating material such as plastic.

Referring back to FIG. 1, the length of housing 104 is shaped to take advantage of repeated motions to be experienced by linear rotary generator 100. In one or more embodiments, housing 104 is a straight tube with elastic bumpers 116 at its two ends. In one or more other embodiments, housing 104 may be a circular or semi-circular tube.

Cavity 106 has a cross-section that provides sufficient room and friction for permanent magnet 102 to roll freely without sliding inside housing 104. In one or more embodiments, housing 104 has a rectangular cross-section. In one or more other embodiments, housing 104 has a circular, semi-circular, oval, or semi-oval cross-section.

Solenoid 108 is a coil of metal wire wound around cavity 106. Solenoid 108 is fixed to the exterior of housing 104 so permanent magnet 102 can roll through the solenoid. Solenoid 108 is wound in one direction, either clockwise or counterclockwise, along the length of cavity 106 in one or multiple layers.

Linear rotary generator 100 may include a rectifier, a regulator, or a rectifier-regulator 118 connected to receive alternating current from the two ends of solenoid 108. A rectifier converts the alternating current to direct current, a regulator regulates the magnitude of the voltage, and a rectifier-regulator performs both functions. The direct current may be used to charge an electrical storage device, such as rechargeable battery 120. Alternatively linear rotary generator 100 may be coupled to supply the alternating current to an electric grid.

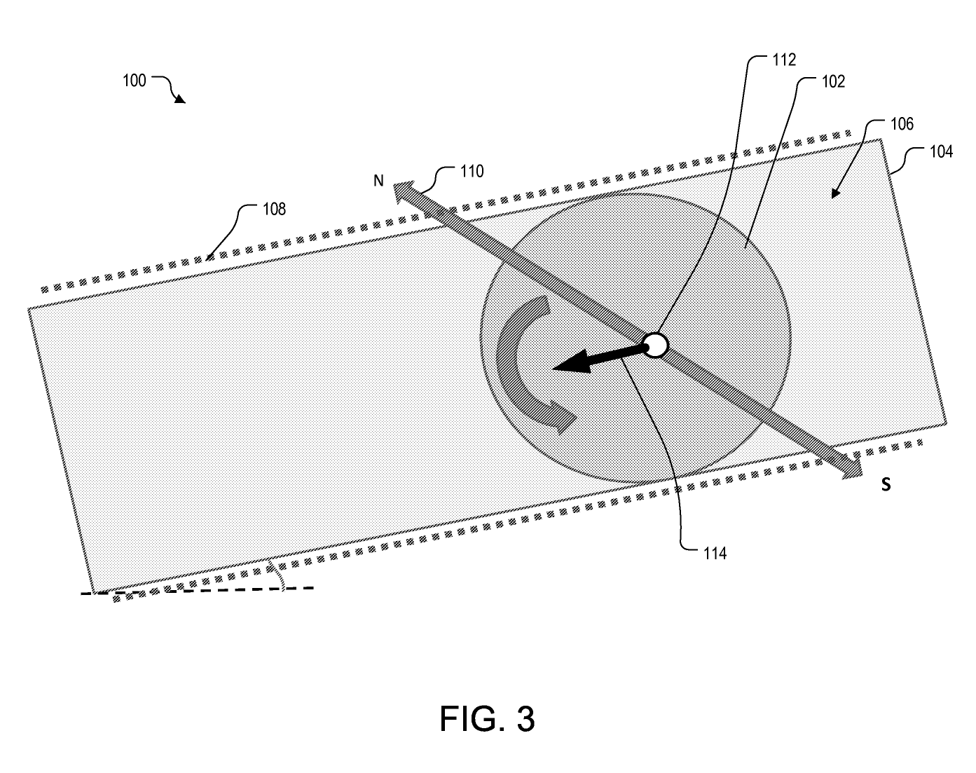

The operation of linear rotary generator 100 is explained hereafter. When linear rotary generator 100 is horizontally level, permanent magnet 102 may remain motionless under its own weight. When linear rotary generator 100 is inclined as shown in FIG. 3, gravity causes permanent magnet 102 to roll downhill in housing 104. Alternatively, the inertia of permanent magnet 102 causes it to roll in housing 104 in one direction as the remainder of linear rotary generator 100 is accelerated in the opposite direction. As permanent magnet 102 rolls, its magnetic field lines rotate and cut through the wire loops of solenoid 108 to induce a current through the solenoid in accordance to physical laws of electromagnetic induction. The current is an alternating current because the magnetic poles of permanent magnet 102 alternatingly cross the wire loops.

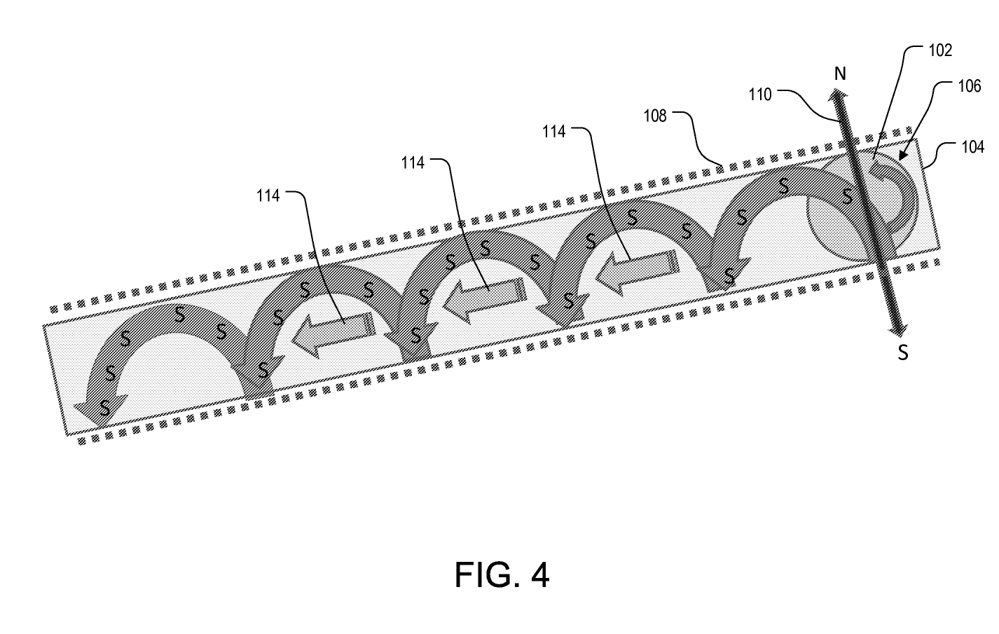

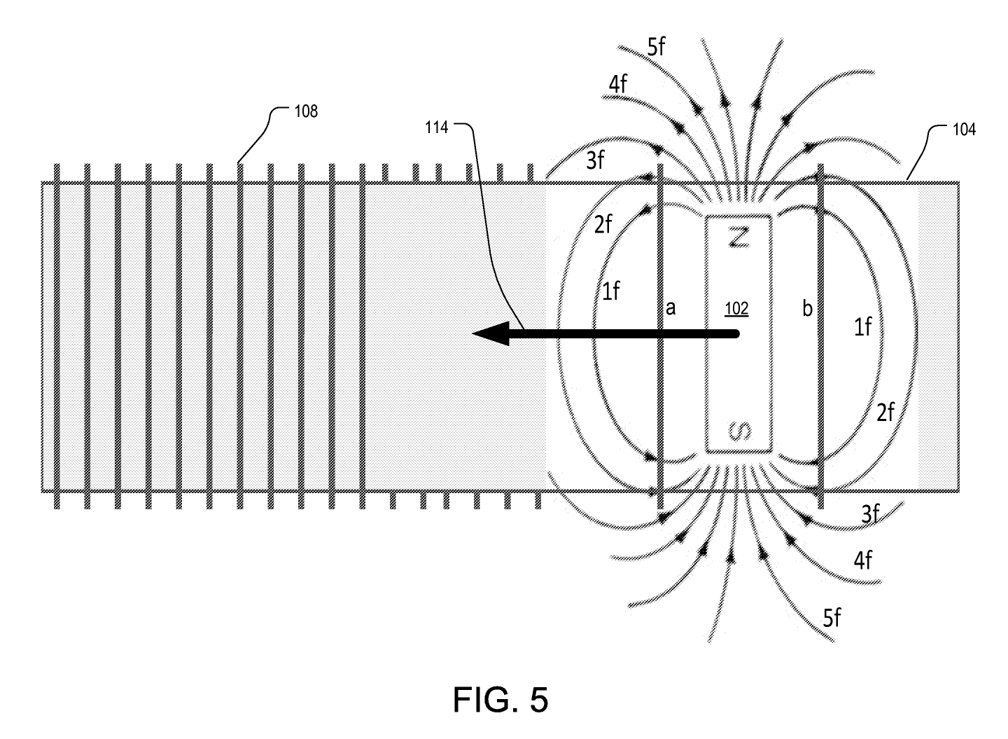

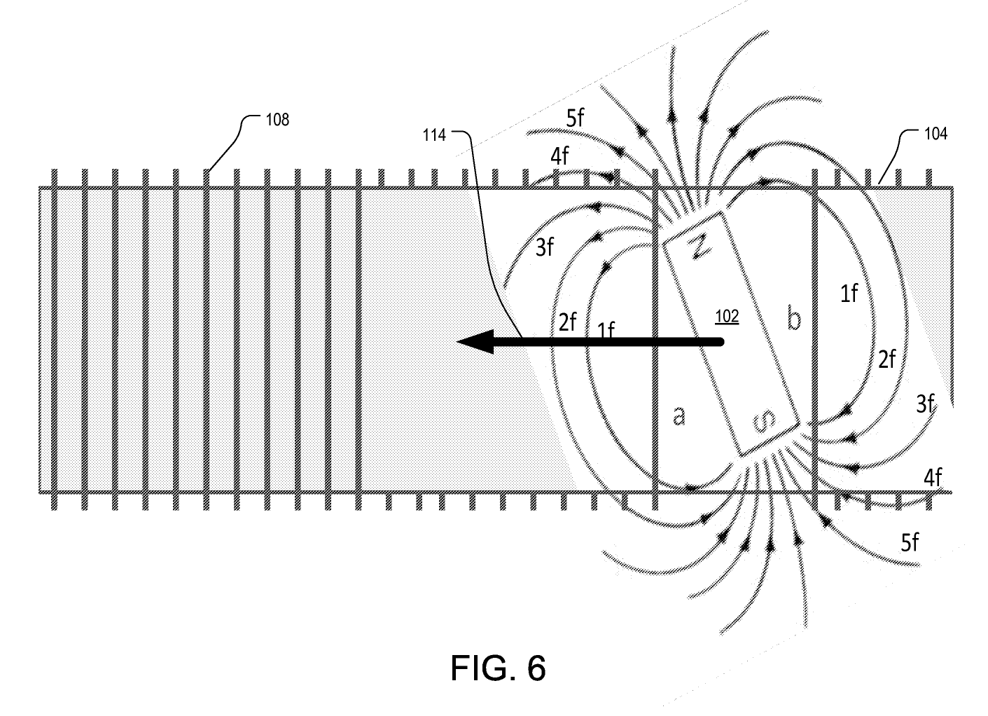

FIG. 4 illustrates a trace of the semi-circular motion of the south pole of permanent magnet 102 as it rolls down housing 104. The motion of the north pole is not shown but it would be a similar trace that is 180 degree out of phase with the south pole. FIG. 5 shows the magnetic field lines 1f and 2f cut across wire loops a and b of solenoid 108. In FIG. 6, permanent magnet 102 has rotated counterclockwise and magnetic field lines 1f, 2f, 3f, 4f, and 5f now cut across wire loops a and b. A comparison of FIGS. 5 and 6 shows the rotation of permanent magnet 102 in housing 104 causes more magnetic field lines to cross and cut the wire loops. In other words, the moving magnetic field crossing solenoid 108 causes magnetic field lines to constantly cut the wire loops and generate a current in solenoid 108. The final result of the rotational travel of permanent magnet 102 inside housing 104 is alternating current and voltage across the two ends of solenoid 108.

Referring back to FIG. 1, in one or more embodiments of the present disclosure, the rolling surface of permanent magnet 102 may have a friction coating 132 and the bottom of housing 104 may have a friction coating 134 to prevent sliding of the permanent magnet. Note that even if permanent magnet 102 slides inside housing 104, a current is still generated but the efficiency of linear rotary generator 100 is reduced.

FIG. 7 illustrates a method to increase the number of rotations of permanent magnet 102 per linear distance traveled in housing 104 in one or more embodiments of the present disclosure. One or two circular gears 702 having a diameter smaller than permanent magnet 102 is fixed to one or both sides of the permanent magnet about rotational axis 112. One or more linear gears 704 are fixed along housing 104 and engage circular gears 702. As linear gears 704 are stationary, circular gears 702 cause permanent magnet 102 to rotate as the permanent magnet moves along housing 104. As circular gears 702 has smaller diameter than permanent magnet 102, the permanent magnet rotates more often than it would directly rolling in housing 104.

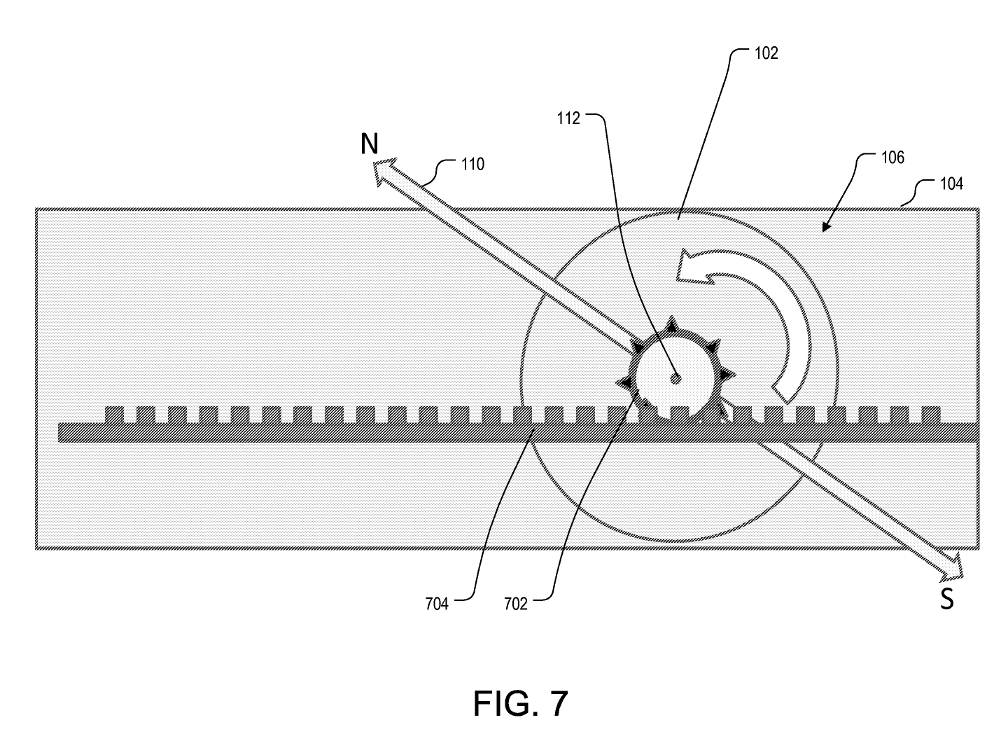

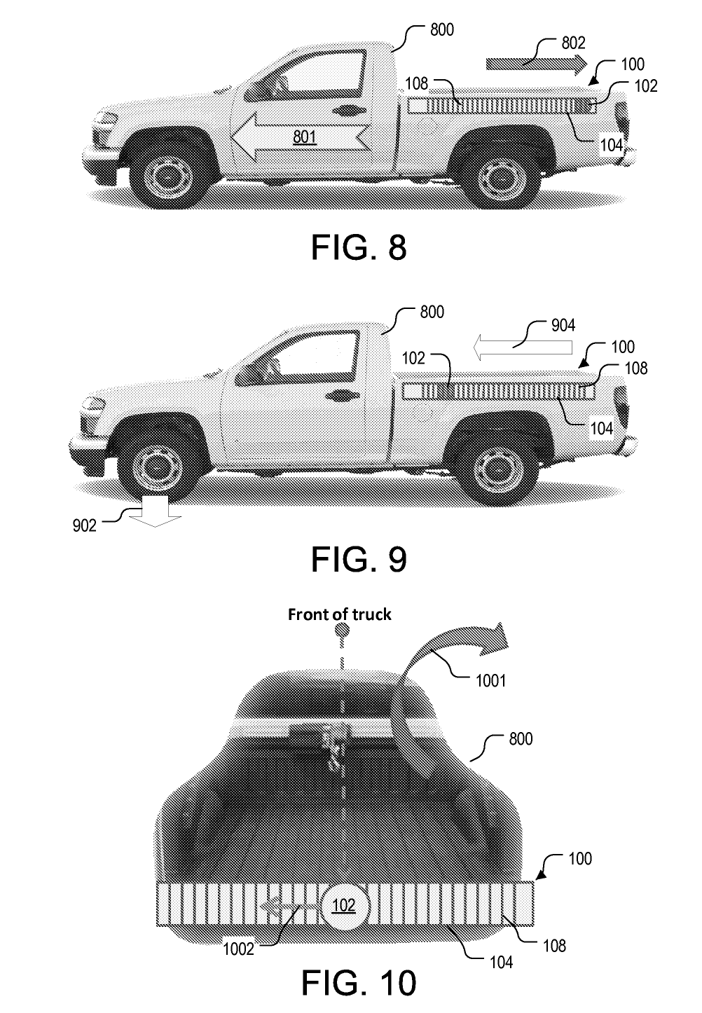

FIGS. 8, 9, and 10 illustrate the application of linear rotary generator 100 to generate power from vehicular motions in one or more embodiments of the present disclosure. Referring to FIG. 8, a linear rotary generator 100 is installed along the length of a land vehicle such as an automobile 800. Automobile 800 may be a hybrid or a fully electric car, and linear rotary generator 100 may be used to recharge the battery of automobile 800 or the electric system of the automobile. When automobile 800 accelerates forward, as indicated by arrow 801, either from stop or a constant velocity, permanent magnet 102 experiences an acceleration 802 backwards. As a result, permanent magnet 102 rolls toward the back of linear rotary generator 100 through solenoid 108 and generates electricity.

FIG. 9 shows the situation of FIG. 8 in reverse. When the breaks of automobile 800 are applied as indicated by a break force 902, the inertia of any loose object in the automobile causes the object to continue forward while the automobile decelerates. This is the reason any occupant in automobile 800 needs to wear a seatbelt in order to prevent the occupant from continuing forward as the automobile decelerates. As a result of break force 902, permanent magnet 102 rolls toward the front of linear rotary generator 100 through solenoid 108 and generates electricity.

Referring to FIG. 10, another linear rotary generator 100 is installed along the width of automobile 800. When automobile 800 turns to the right as indicated by arrow 1001, permanent magnet 102 experiences an acceleration 1002 to the left. As a result, permanent magnet 102 rolls toward the left of linear rotary generator 100 through solenoid 108 and generates electricity. The reverse operation occurs when automobile 800 turns to the left.

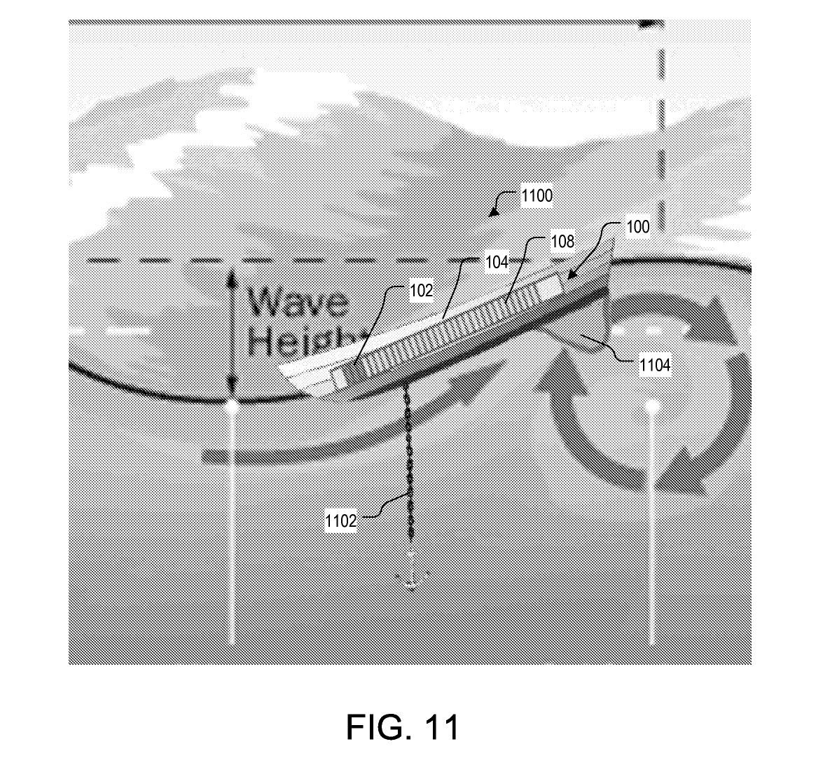

FIG. 11 illustrates the application of linear rotary generator 100 to generate power from wave motions of a body of water in one or more embodiments of the present disclosure. A linear rotary generator 100 is installed along the length of a watercraft such as a boat 1100. Boat 1100 includes an anchor 1102 that keeps the boat substantially stationary to experience the full up and down motion of the waves. Anchor 1102 may reach the bottom of the body of water. Boat 1100 also includes one or more fins 1104 that keep the boat pointed perpendicular to the direction of the waves.

When boat 1100 is at the back of a wave so the bow of the boat is down and the stern of the ship is up, permanent magnet 102 rolls forward toward the front of linear rotary generator 100 and generates electricity. Conversely but not illustrated, when boat 1200 is at the front of a wave so the bow of the boat is up and the stern of the ship is down, permanent magnet 102 rolls backward toward the back of linear rotary generator 100 and generates electricity. The electricity may be used to charge a rechargeable battery that powers boat 1100, or be supplied by transmission lines to the electric grid back onshore.

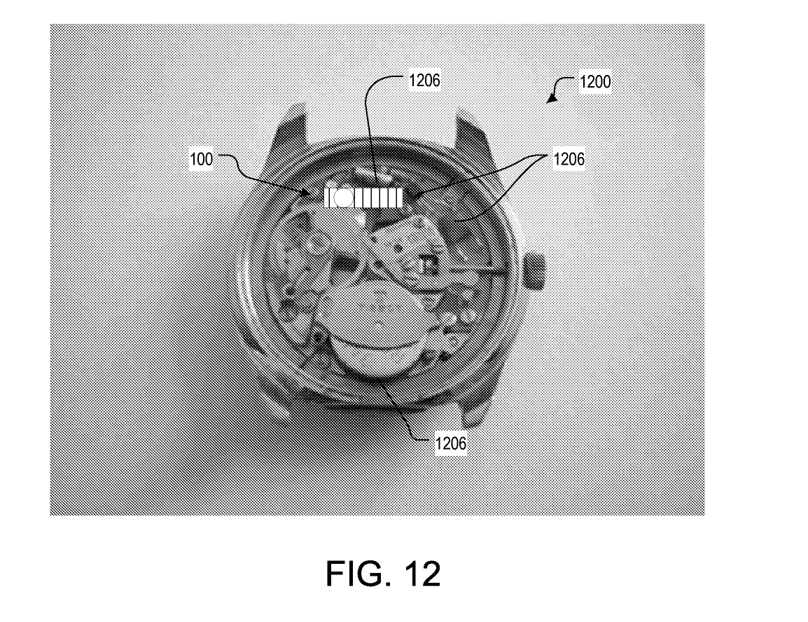

FIG. 12 illustrates the application of linear rotary generator 100 to generate power from passive body motions in one or more embodiments of the present disclosure. A linear rotary generator 100 is installed inside a watch 1200. The passive movement of watch 1200 on a person's wrist causes linear rotary generator 100 to generate electricity. A rectifier-regulator 1202 converts the alternating current from linear rotary generator 100 into a direct current applied across a capacitor 1204, which is coupled to charge a rechargeable battery 1206.

In one or more embodiments of the present disclosure, linear rotary generator 100 may also be applied to other objects, such as a floating platform (e.g., an oil rig), a shoe, an electronic device (e.g., an iPhone), or a sporting gear.

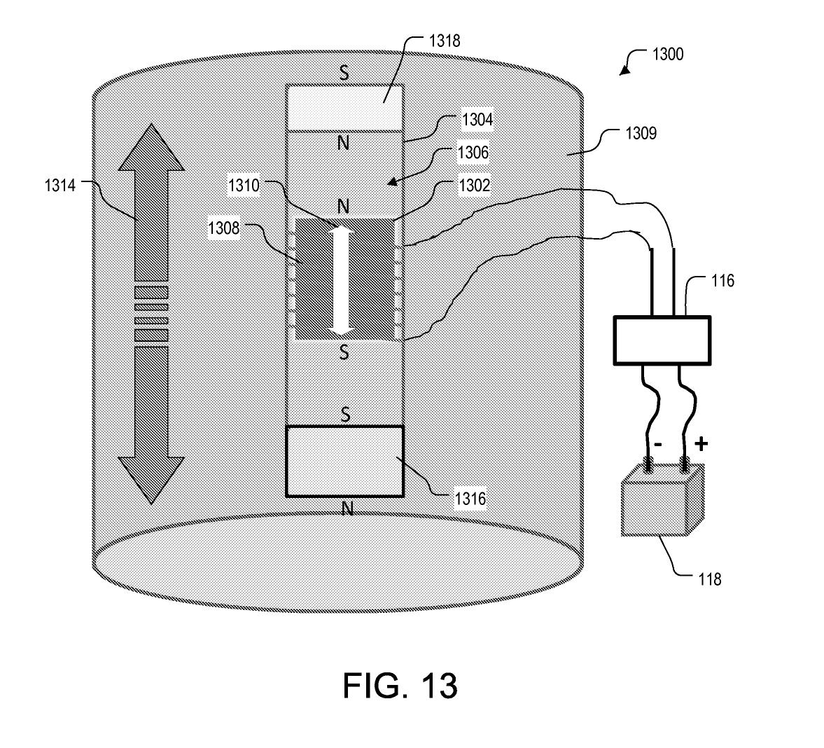

FIG. 13 is a perspective view of a linear suspended magnet generator 1300 in one or more embodiments of the present disclosure. Linear suspended magnet generator 1300 includes a permanent magnet 1302, a housing 1304 defining a cavity 1306 receiving the permanent magnet, a solenoid 1308 about the mid-portion of the cavity, and an optional magnetic shield 1309 around the housing.

Housing 1304 is a vertical, linear tube. Permanent magnet 1302 has a magnetic axis 1310 along its vertical direction 1314 of motion within housing 1304. Magnetic axis 1310 does not rotate about a rotational axis perpendicular to direction 1314 of motion.

Linear suspended magnet generator 1300 includes magnetic bumpers 1316 and 1318 placed at the two ends of housing 1304. Magnetic bumpers 1316 and 1318 create two magnetic springs that suspend permanent magnet 1302 about the mid-portion of cavity 1306 within solenoid 1308. For example, the south pole of magnetic bumper 1316 faces the south pole of permanent magnet 1302, and the north pole of magnetic bumper 1318 faces the north pole of the permanent magnet. In this configuration, linear suspended magnet generator 1300 is very sensitive to vertical vibrations.

The operation of linear suspended magnet generator 1300 is explained hereafter. When linear suspended magnet generator 1300 experiences up and down motions, the inertia of permanent magnet 1302 causes it to initially remain stationary relative to the rest of the generator. As a result, solenoid 1308 moves up and down relative to permanent magnet 1302 and induces a current at the two ends of the solenoid. After some time, permanent magnet 1302 gains move up and down motion as a result of magnetic induction forces from solenoid 1308 and magnetic repulsion forces from magnetic bumpers 1316 and 1318. The relative movements between permanent magnet 1302 and solenoid 1308 continue to induce current.

Linear suspended magnet generator 1300 may include a rectifier-regulator 116 connected to receive alternating current from solenoid 1308. Rectifier-regulator 116 converts the alternating current to direct current and voltage. The direct current may be used to charge an electrical storage device, such as rechargeable battery 118. Alternatively linear rotary generator 1300 may be coupled to supply the alternating current to an electric grid.

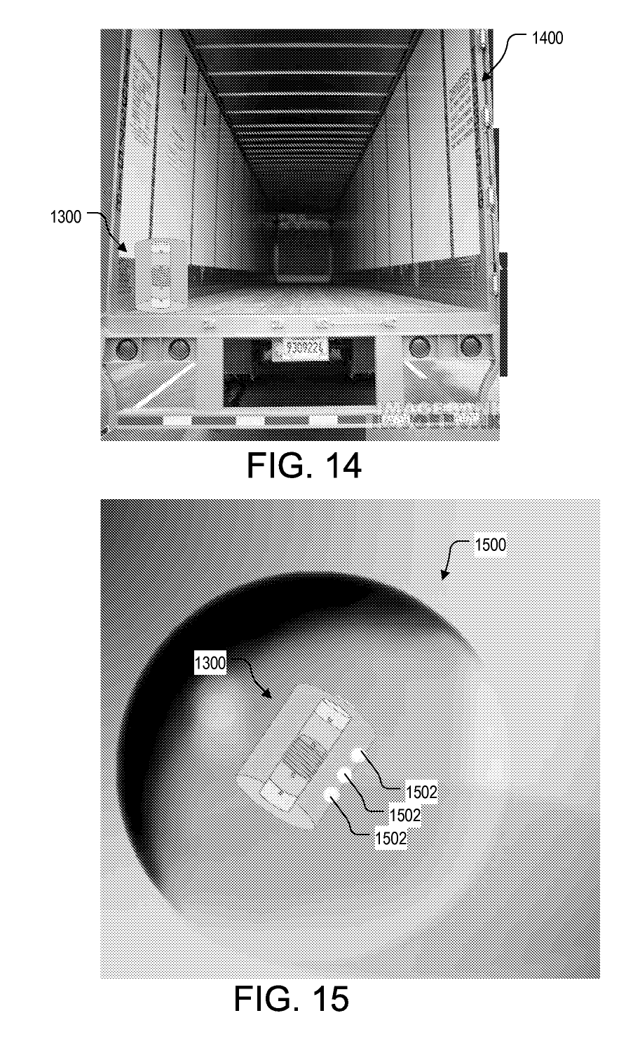

FIG. 14 illustrates the application of linear suspended magnet generator 1300 to generate power from vertical vibrating motion in one or more embodiments of the present disclosure. Linear suspended magnet generator 1300 is fixed vertically to a vehicle such as a trailer 1400 of a semi-trailer truck. Linear suspended magnet generator 1300 may be used to recharge the battery of the semi-trailer truck or to the electronic system of the semi-trailer truck.

FIG. 15 illustrates the application of linear suspended magnet generator 1300 to a toy ball 1500 in one or more embodiments of the present disclosure. Linear suspended magnet generator 1300 is coupled to one or more light sources 1502 so they light up when toy ball 1500 experiences motion, such as bouncing up and down.

The operation of toy ball 1500 is explained hereafter. When toy ball 1500 is thrown downward toward the ground, the inertia of permanent magnet 1302 initially causes it to remain stationary relative to the remainder of linear suspended magnet generator 1300. As a result, solenoid 1308 moves relative to permanent magnet 1302 and induces a current at the two ends of the solenoid. When toy ball 1500 hits the ground, the inertia of permanent magnet 1302 causes it to continue to move relative to the remainder of linear suspended magnet generator 1300. As a result, permanent magnet 1302 moves through solenoid 1308 and induces a current at the two ends of the solenoid. Toy ball 1500 then bounces upward before falling downward again, repeating the above process.

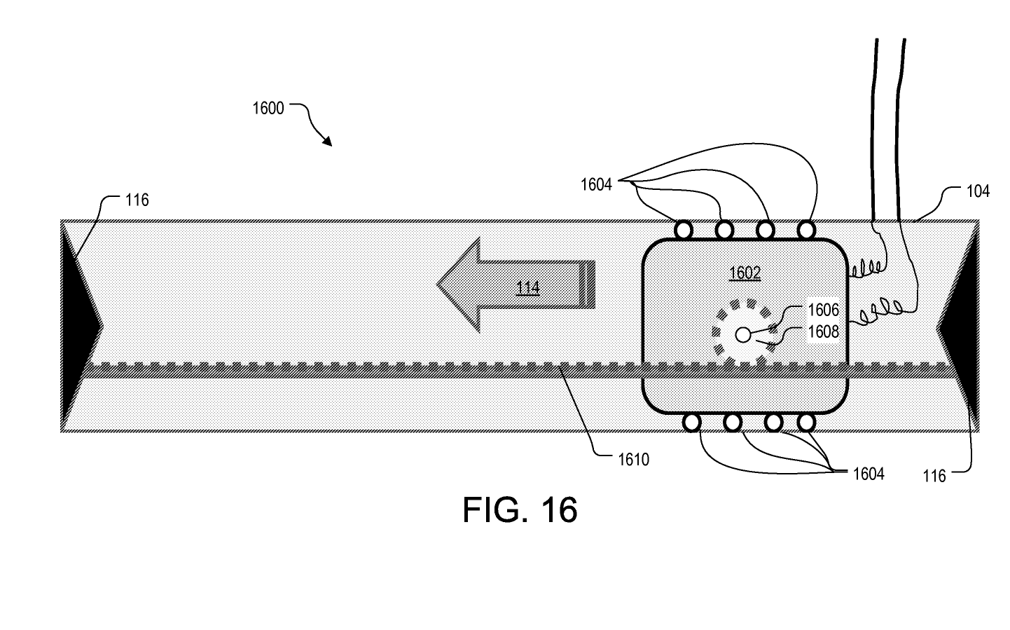

FIG. 16 illustrates a linear rotary generator 1600 where permanent magnet and solenoid are replaced with an alternator 1602 in one or more embodiments of the present disclosure. Alternator 1602 is supported by ball bearings 1604 within cavity 106 of housing 104. A rotor shaft 1606 of alternator 1602 is fixed to a circular gear 1608, which engages a linear gear 1610 fixed along the length of housing 104. Wires extend from alternator 1602 to provide an alternating current generated from motion 114 of the alternator.

The operation of linear rotary generator 1600 is similar to linear rotary generator 100 previously explained. When linear rotary generator 1600 is horizontally level, alternator 1602 may remain motionless under its own weight. When linear rotary generator 1600 is inclined, gravity causes alternator 1602 to slide downhill in the housing. As alternator 1602 slides, linear gear 1610 rotates circular gear 1608 and generates an alternating current. Alternatively, the inertia of alternator 2102 causes it to slide relative to housing 104 in one direction as the remainder of linear rotary generator 1600 is accelerated in the opposite direction.

Various other adaptations and combinations of features of the embodiments disclosed are within the scope of the present disclosure. Numerous embodiments are encompassed by the following claims.

What is claimed is:

1. A linear rotary generator, comprising:
a magnet comprising a magnetic axis that rotates about a rotational axis as the magnet rolls along a direction perpendicular to the rotational axis;
a housing defining a cavity receiving the magnet, wherein the magnet is free to substantially roll along the cavity without sliding; and
a solenoid around the cavity, wherein an alternating current is induced in the solenoid as the magnet rolls through the solenoid.

2. The linear rotary generator of claim 1, wherein the magnetic axis is substantially perpendicular to the rotational axis.

3. The linear rotary generator of claim 2, wherein the magnet is cylindrical about the rotational axis.

4. The linear rotary generator of claim 3, wherein the housing comprises a linear tube with a rectangular, circular, semi-circular, oval, or semi-oval cross-section.

5. The linear rotary generator of claim 4, further comprising bumpers at the two ends of the housing.

6. The linear rotary generator of claim 5, wherein the solenoid comprises a coil of metal wire.

7. The linear rotary generator of claim 1, further comprising a cylindrical jacket encasing the magnet, the cylindrical casing defining the rotational axis.

8. The linear rotary generator of claim 1, further comprising:
a rectifier coupled to the solenoid; and
an electrical storage device coupled to the rectifier.

9. The linear rotary generator of claim 3, wherein the housing comprises a circular tube with a rectangular, circular, semi-circular, oval, or semi-oval cross-section.

10. The linear rotary generator of claim 1, wherein the magnet and the cavity comprise friction coatings.

11. The linear rotary generator of claim 1, further comprising:
a circular gear fixed to the magnet; and
a linear gear fixed to the housing and engaging the circular gear.

12. A system, comprising:
an object experiencing motion; and
a linear rotary generator fixed to the object, the rotary power generator comprising:
a magnet comprising a magnetic axis that rotates about a rotational axis as the magnet rolls along a direction perpendicular to the rotational axis;
a housing defining a cavity receiving the magnet, wherein the magnet is free to substantially roll along the cavity without sliding; and
a solenoid around the cavity, wherein an alternating current is induced in the solenoid as the magnet rolls through the solenoid.

13. The system of claim 12, wherein the object is a land vehicle, a watch, a watercraft, a shoe, an electronic device, or a sporting gear.

14. The system of claim 12, wherein the object is a boat comprising:
an anchor that keeps the boat relative stationary in a body of water; and
one or more fins that point the boat perpendicular to waves.

15. A method generating electric power, comprising:
generating electricity by rolling a magnet along a direction of motion in a cavity so a magnetic axis of the magnet rotates about a rotational axis substantially perpendicular to the direction of motion, wherein the magnet induces an alternating current in a solenoid around the cavity as the magnet rolls through the solenoid.

16. The method of claim 15, wherein the magnetic axis is substantially perpendicular to the rotational axis.

17. The method of claim 16, wherein the magnet is cylindrical about the rotational axis.

18. The method of claim 17, wherein the housing comprises a linear tube with a rectangular, circular, semi-circular, oval, or semi-oval cross-section.

19. The method of claim 18, further comprising repelling the magnet at the two ends of the housing.

20. The method of claim 18, wherein the solenoid comprises a coil of metal wire.

21. The method of claim 15, wherein the magnet is encased in a cylindrical jacket defining the rotational axis.

22. The method of claim 15, further comprising:
rectifying the alternating current from the solenoid to produce a direct current; and
storing the direct current.

23. The method of claim 16, wherein the housing comprises a circular tube with a rectangular, circular, semi-circular, oval, or semi-oval cross-section.

24. The method of claim 15, wherein the magnet and the cavity comprise friction coatings.

25. The method of claim 15, wherein rolling the magnet comprises rotating the magnet with a circular gear fixed to the magnet engaged to a linear gear fixed to the housing.

26. The method of claim 15, further comprising:
providing the electricity to an object local to the generating the electricity.

27. The method of claim 26, wherein the object is a land vehicle, a watch, a watercraft, a shoe, an electronic device, or a sporting gear.

28. A system, comprising:
an object experiencing up and down motions; and
a linear suspended magnet generator fixed to the object, the generator comprising:
a magnet comprising a magnetic axis along a direction of motion of the magnet;
a housing defining a cavity receiving the magnet;
first and second magnetic bumpers at the two ends of the housing suspending the magnet about a mid-portion of the cavity; and
a solenoid about the mid-portion of the cavity.

29. The system of claim 28, wherein the object is a trailer of a semi-trailer truck, and the linear suspended magnet generator is vertically oriented.

30. The system of claim 28, wherein the object is a ball.

31. A linear rotary generator, comprising:
an alternator comprising a rotor shaft;
a housing defining a cavity receiving the alternator, wherein the alternator is free to slide along the cavity;
a linear gear fixed along the housing; and
a circular gear fixed to the rotor shaft and engaging the linear gear.

32. A method generating electric power, comprising:
generating electricity by sliding an alternator along a cavity so a linear gear fixed along the housing turns a circular gear fixed to a rotor shaft of the alternator.
